(19) United States
(12) Patent Application Publication
(10) Pub. No.: US 2026/0197391 A1
(43) Pub. Date: Jul. 9, 2026

(54) Audio Device and Terminal Device

(71) Applicant: Honor Device Co., Ltd., Shenzhen (CN)

(72) Inventors: Chuncheng Mao, Shenzhen (CN); Jinkun Liu, Shenzhen (CN); Jiaxuan Cui, Shenzhen (CN); Dong Ma, Shenzhen (CN)

(21) Appl. No.: 18/863,220

(22) PCT Filed: Apr. 27, 2023
(86) PCT No.: PCT/CN2023/091232

§ 371 Date: Nov. 5, 2024

(30) Foreign Application Priority Data
Jun. 24, 2022 (CN) 202210731107.8

(51) Int. Cl. H04M 1/03; H04R 1/04; H04R 1/08

(52) U.S. Cl. CPC H04M 1/03; H04R 1/04; H04R 1/083; H04R 2499/11

(57) ABSTRACT

An audio device and a terminal device. The audio device includes a microphone, a flexible circuit board, and a support. The microphone is located between the support and the flexible circuit board. A contact region between the flexible circuit board and the microphone includes a first hole for an airflow of audio energy to circulate. In the audio device, the microphone is located between the support and the flexible circuit board, and the support can provide a supporting function. Therefore, through the audio device, a risk that the microphone falls off the support can be reduced and lightening and thinning of the terminal device are promoted.

This application claims priority to Chinese Patent Application No. 202210731107.8, filed with the China National Intellectual Property Administration on Jun. 24, 2022 and entitled “AUDIO DEVICE AND TERMINAL DEVICE”, which is incorporated herein by reference in its entirety.

### TECHNICAL FIELD

This application relates to the field of electronic technologies, and in particular, to an audio device and a terminal device.

### BACKGROUND

Currently, to meet a calling need of users, mobile phones generally have an audio device such as a microphone (microphone, MIC) arranged therein. Further, to improve a noise reduction effect, some mobile phones are provided with the microphone not only on a bottom or a top, but also on a back. The microphone arranged on the back of the mobile phones may be referred to as a back MIC.

When the back MIC needs to be arranged in a mobile phone and a circuit board in the mobile phone is a flexible circuit board, the back MIC is usually mounted in the mobile phone in a manner shown in FIG. 1. Referring to FIG. 1, a microphone 110 is usually arranged on a flexible circuit board 120. The flexible circuit board is bonded to a support 130 of a mobile phone. In addition, to reduce a risk that the microphone 110 falls off the support 130, a supporting member 140 configured to support the microphone 110 is usually arranged below the microphone 110.

However, in this solution, an additional space needs to be reserved in the mobile phone for the supporting member.

### SUMMARY

In the prior art, to prevent a microphone from falling off a support, a supporting member configured to support the microphone needs to be arranged. Therefore, in a terminal device, a space needs to be reserved for the supporting member. To resolve the technical problem, embodiments of this application provide an audio device and a terminal device.

In a first aspect, an embodiment of this application provides an audio device, including:
a microphone, a flexible circuit board, and a support.

The microphone is located between the support and the flexible circuit board.

A contact region between the flexible circuit board and the microphone includes a first hole for an airflow of audio to circulate.

In the audio device, the microphone is located between the support and the flexible circuit board, and the support can provide a supporting function. Therefore, through the audio device, a risk that the microphone falls off the support can be reduced even if no supporting member is arranged.

In a possible implementation, the audio device further includes:
a first reinforcing member.

The first reinforcing member is located between the support and the flexible circuit board, and is located around the microphone.

In a possible implementation, a first side of the first reinforcing member is welded to the support, or the first side of the first reinforcing member is bonded to the support through a back adhesive.

A second side of the first reinforcing member is welded to the flexible circuit board, or the second side of the first reinforcing member is bonded to the flexible circuit board through the back adhesive, and the first side of the first reinforcing member is opposite to the second side of the first reinforcing member.

In a possible implementation, the first reinforcing member includes a metal member or a composite fiber member.

Through the first reinforcing member, strength of the audio device can be improved.

In a possible implementation, the audio device further includes:
a seal member.

When the audio device is arranged in the terminal device, a space between the flexible circuit board and a structural member of the terminal device is sealed by the seal member.

The seal member includes a second hole for the airflow of the audio to circulate.

In a possible implementation, the seal member includes foam and/or a back adhesive.

Through the seal member, sealing of the flexible circuit board and the structural member can be achieved.

In a possible implementation, the audio device further includes:
a second reinforcing member.

The second reinforcing member is located between the flexible circuit board and the seal member.

The second reinforcing member includes a third hole for the airflow of the audio to circulate.

Through the second reinforcing member, the strength of the audio device can be improved.

In a possible implementation, a first side of the second reinforcing member is welded to the flexible circuit board, or the first side of the second reinforcing member is bonded to the flexible circuit board through the back adhesive.

A second side of the second reinforcing member is welded to the seal member, or the second side of the second reinforcing member is bonded to the seal member through the back adhesive, and the first side of the second reinforcing member is opposite to the second side of the second reinforcing member.

In a possible implementation, a first surface of the flexible circuit board covers a surface of the second side of the first reinforcing member.

The first surface of the flexible circuit board is a surface of the flexible circuit board connected to the first reinforcing member.

In a possible implementation, a second surface of the flexible circuit board covers a surface of the first side of the second reinforcing member.

The second surface of the flexible circuit board is a surface of the flexible circuit board connected to the first reinforcing member.

In a possible implementation, the support includes a groove.

The microphone is located in the groove.

In a possible implementation, a depth of the groove is in a range of 0.5 mm to 1.5 mm.

A distance between a bottom of the microphone and the groove is in a range of 0.05 mm to 0.25 mm.

In a possible implementation, the structural member includes a cover or a housing of the terminal device.

In a second aspect, an embodiment of this application provides a terminal device, including:
the audio device in the first aspect.

In a possible implementation, a screen of the terminal device is a flexible screen.

In the audio device, the microphone is located between the support and the flexible circuit board, and the support can provide a supporting function. Therefore, through the audio device, a risk that the microphone falls off the support can be reduced even if no supporting member is arranged, thereby resolving a problem in the prior art that a space needs to be reserved in a terminal device for a supporting member due to a need to arrange the supporting member.

Further, in the solutions of this application, because no space needs to be reserved in the terminal device for the supporting member, the terminal device can be lighter and thinner.

### BRIEF DESCRIPTION OF DRAWINGS

FIG. 1 is a schematic structural diagram of an audio device;

FIG. 2 is a schematic structural diagram of another audio device;

FIG. 3 is a schematic structural diagram of a terminal device according to an embodiment of this application;

FIG. 4 is a partial schematic structural exploded view of the terminal device according to an embodiment of this application;

FIG. 5 is a schematic structural diagram of an audio device according to an embodiment of this application;

FIG. 6 is a schematic structural diagram of another audio device according to an embodiment of this application; and

FIG. 7 is a schematic structural diagram of another audio device according to an embodiment of this application.

### DESCRIPTION OF EMBODIMENTS

Technical solutions in embodiments of this application are described below with reference to drawings in embodiments of this application.

Terms used in the following embodiments are merely intended to describe particular embodiments, and are not intended to limit this application. As used in the specification and the claims of this application, a singular expression “one”, “a/an”, “the”, “foregoing”, “the”, or “this” is intended to include an expression “one or more”, unless clearly indicated to the contrary in the context. It should be further understood that, in the following embodiments of this application, “at least one” and “one or more” mean one, two, or more than two. A term “and/or” is used to describe an association relationship between associated objects and represents that three relationships may exist. For example, A and/or B may represent: only A exists, both A and B exist, and only B exists. A and B may be singular or plural. A character “/” generally indicates that the associated objects are in an “or” relationship.

Reference to “one embodiment” or “some embodiments” described in this specification means that a specific characteristic, structure, or feature described in combination with the embodiment is included in one or more embodiments of this application. Therefore, statements “in an embodiment”, “in some embodiments”, “in some other embodiments”, “in some additional embodiments”, and the like throughout this specification do not necessarily refer to the same embodiment, but mean “one or more but not all embodiments”, unless otherwise specially emphasized in another manner. Terms “comprise”, “include”, “have”, and variations thereof all mean “including but not limited to”, unless otherwise specially emphasized in another manner.

For a clear and concise description of the following embodiments, a brief introduction the prior art is provided first.

Currently, to meet user demands, some terminal devices are provided with an audio device, that is, a microphone (microphone, MIC). The microphone is arranged on a back of some terminal devices. In other words, a sound outlet of the microphone is located on the back of the terminal devices.

For example, some high-end mobile phones are provided with three MICs. A MIC with a sound outlet located on a bottom of a mobile phone is usually referred to as a main MIC, a MIC with a sound outlet located on a top of the mobile phone may be referred to as a secondary MIC, and a MIC with a sound outlet located on a back of the mobile phone may be referred to as a third MIC or a back MIC. Arranging three MICs can improve a noise reduction effect of a mobile phone, and improve sound quality of the mobile phone.

In addition, if a MIC is arranged on a back of a terminal device, a stack design of the MIC may adopt a hard board solution or a flexible board solution based on a material of a circuit board on which the MIC is to be welded. The hard board solution refers to welding a MIC to a hard circuit board. A structural diagram of the solution may be shown in FIG. 2. Referring to FIG. 2, in the hard board solution, a MIC 210 is welded to a hard circuit board 220, a hole is provided on the hard circuit board 220, and a space between the hard circuit board and an exterior structural member 230 of a terminal device is sealed by a seal member 240.

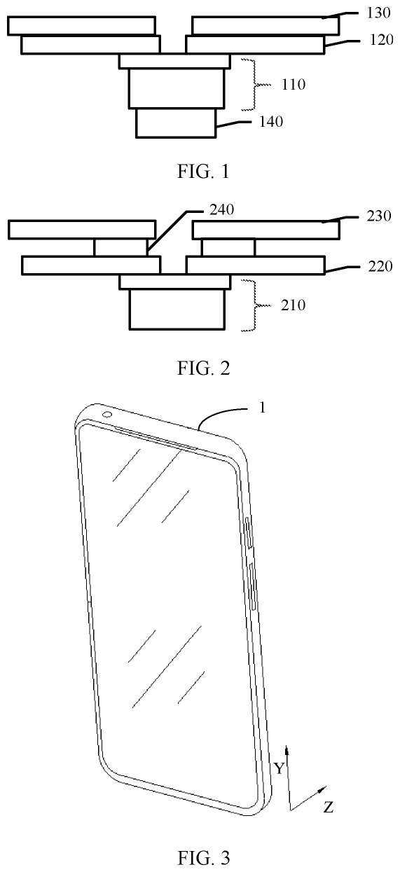

The flexible board solution refers arranging a MIC on a flexible circuit board. A structural diagram of the solution may be shown in FIG. 1. In the solution, the MIC is arranged on the flexible circuit board. During assembly of a whole machine, the flexible circuit board provided with the MIC is usually bonded to a lower surface of a support of a terminal device, to mount the flexible circuit board provided with the MIC to the whole machine together with the support.

Further, the flexible board solution has a risk that the MIC falls off the support. For example, because the flexible circuit board has a characteristic of being bendable, the MIC may fall off the support after a plurality of times of bending. Alternatively, adhesion of a back adhesive bonding the flexible circuit board to the support decreases with time of use, which may cause the MIC and the flexible circuit board to fall off the support.

To reduce the risk of falling off of the MIC, referring to FIG. 1, currently, a supporting member configured to support the MIC is usually arranged below the MIC. However, to arrange the supporting member below the MIC, a space needs to be reserved in the terminal device for the supporting member.

In view of the problem in the existing flexible board solution that a supporting member needs to be arranged to reduce a risk of falling off of a MIC and therefore a space needs to be reserved in a terminal device for the supporting member to arrange, this application provides an audio device and a terminal device including the audio device. Through the audio device, the risk of falling off of a MIC can be reduced without a need to arrange a supporting member.

A terminal device 1 in embodiments of this application may be referred to as user equipment (user equipment, UE), a terminal (terminal), a terminal device, or the like. For example, the terminal device 1 may be a mobile terminal or a fixed terminal having a display, such as a tablet computer (portable android device, PAD), a personal digital assistant (personal digital assistant, PDA), a notebook computer, a handheld device having a wireless communication function, a computing device, an on-board device, a wearable device, a virtual reality (virtual reality, VR) terminal device, an augmented reality (augmented reality, AR) terminal device, a wireless terminal in industrial control (industrial control), a wireless terminal in self driving (self driving), a wireless terminal in remote medical (remote medical), a wireless terminal in a smart grid (smart grid), a wireless terminal in transportation safety (transportation safety), a wireless terminal in smart city (smart city), or a wireless terminal in smart home (smart home). A form of the terminal device is not specifically limited in embodiments of this application.

FIG. 3 schematically shows a structure of the terminal device 1 according to an embodiment. As shown in FIG. 3, in this embodiment of this application, a description is provided by using an example in which a terminal device 3 is a handheld device having a wireless communication function. The handheld device may be a mobile phone or the like. In addition, in FIG. 3, a short side of the mobile phone is an x axis of a coordinate system, and a side on which a height of the mobile phone is located is a y axis of the coordinate system.

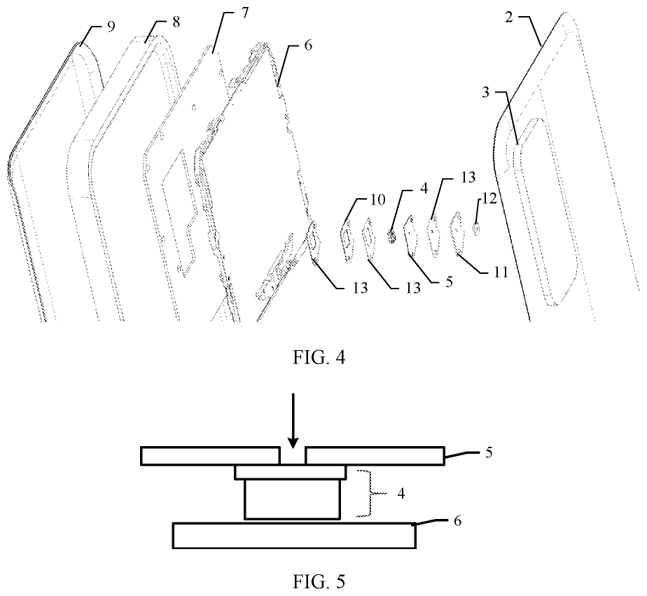

FIG. 4 schematically shows a partial exploded structure of the terminal device according to an embodiment. As shown in FIG. 3 and FIG. 4, the terminal device 1 in this embodiment of this application includes a structural member 2, a decorative member 3, a microphone 4, a flexible circuit board 5, a support 6, a main board 7, a middle frame 8, and a screen assembly 9. In addition, the terminal device may further include a battery assembly and various types of electronic elements. In addition, in a coordinate system shown in FIG. 4, the short side of the terminal device 1 is an x axis of the coordinate system, the side on which the height of the terminal device 1 is located is a y axis of the coordinate system, and a long side of the terminal device 1 is a z axis of the coordinate system.

The screen assembly 9 is mounted to the middle frame 8, and a display region of the screen assembly 9 is exposed to present image information to a user. The main board 7 and the battery assembly are arranged in the terminal device 1, and are located on inner sides of structural member 2 and the screen assembly 9, so that a user cannot easily observe the main board 7 and the battery assembly from outside of the terminal device 1. The electronic element is arranged on the main board 7. The electronic element includes but is not limited to a processor, an antenna module, a Bluetooth module, a wireless communication module, a global positioning system (global positioning system, GPS) module, a power supply and a charging module, a screen display and an operating module, a distance sensor, a light sensor, an earphone jack, and a universal serial bus (universal serial bus, USB) interface.

In addition, in a feasible design, the structural member 2 may be a cover or a housing of the terminal device 1. For example, if the terminal device 1 is a mobile phone, the structural member 2 may be a battery cover of the mobile phone.

Because an internal space of the terminal device 1 is relatively small, the electronic elements are highly integrated on the main board 7 to minimize a volume of the main board 7 and reduce a space occupation of the main board 7. Optionally, to meet a design requirement on the internal space of the terminal device 1, the main board 7 may have separate pieces. Different electronic elements are arranged on the main board 7 having separate pieces, to realize corresponding functions.

The battery assembly is configured to supply electrical energy to the terminal device 1, to ensure normal operation of the terminal device 1. For example, the battery assembly may supply electrical energy to the screen assembly 9, so that the screen assembly 9 can display image information or complete corresponding operation instructions. Alternatively, the battery assembly may supply electrical energy to the main board 7, to ensure normal operation of the electronic elements on the main board 7.

The battery assembly includes a battery and a battery protection circuit board. The battery may be a lithium ion battery, such as a lithium iron phosphate battery. The battery is a structural member that can convert chemical energy to electrical energy. The battery includes a positive tab and a negative tab having opposite polarities.

In a height direction Y of the structural member, the battery protection circuit board is arranged on a side of the battery. The battery protection circuit board is a plate-like structure having a predetermined thickness. The battery protection circuit board is configured to detect an operating status of the battery, to reduce a possibility of overcharging, over-discharging, a short circuit, or ultra-high temperature charging/discharging of the battery, thereby protecting the battery. The battery protection circuit board includes a protection circuit. The positive tab and the negative tab of the battery may be respectively welded with the protection circuit, to realize electrical connection between the battery and the battery protection circuit board.

Because the terminal device 1 is a frequently-used product in daily life, users have an increasing demand for lightening and thinning or miniaturization of the terminal device 1. The lightened and thinned or miniaturized terminal device 1 can effectively reduce fatigue during use of the terminal device 1 and difficulty in carrying the electronic device for users. In addition, users have an increasing demand for functions of the terminal device 1. For example, the terminal device 1 may include a functional device for photographing, light sensing, illumination, or the like, so that the terminal device 1 can realize various functions. For example, the functional device is a camera module for photographing. To obtain more desirable imaging quality, the camera module needs to be designed with a relatively large size to arrange an optical lens set or an optical sensor with more desirable performance. However, a camera module with a relatively large size limits a thickness of the terminal device 1. To realize lightening and thinning or miniaturization of the terminal device 1 and obtain desirable image quality, the decorative member 3 needs to be arranged on the structural member of the terminal device 1 to shield or mask the functional device. Therefore, not only a corresponding function is realized by using the functional device, but also a pleasing appearance of the terminal device 1 is realized. Moreover, a thickness of a part other than the functional device may be designed to be smaller, thereby realizing lightening and thinning or miniaturization of the terminal device 1. The decorative member 3 is arranged on the structural member and may be connected to the structural member. Because a part of the decorative member 3 is higher than an outer surface of the structural member, an overall thickness of a region on the terminal device 1 where the decorative member is arranged is relatively large. The outer surface of the structural member is a surface facing an external environment. A user may observe or touch the external surface of the structural member when using the terminal device 1.

In addition, referring to FIG. 4, in the terminal device, the microphone 4, the flexible circuit board 5, and the support 6 form the audio device of the terminal device. The microphone 4 is located between the support 6 and the flexible circuit board 5. In addition, a contact region between the flexible circuit board 5 and the microphone 4 includes a first hole for an airflow of audio to circulate.

The microphone 4 is located between the support 6 and the flexible circuit board 5, and the support 6 can provide a supporting function. Therefore, a risk that the microphone 4 falls off the support 6 is reduced. Moreover, through the audio device, no supporting member needs to be arranged, which resolves a problem in the prior art that a space needs to be reserved in the terminal device 1 due to a need to arrange a supporting member. In addition, after the audio device is mounted to the terminal device 1, an airflow of audio may flow into the microphone 4 from outside of the terminal device 1 through the first hole.

Further, the terminal device 1 may further include a first reinforcing member 10, a second reinforcing member 11, a seal member 12, and a back adhesive 13. The first reinforcing member 10 and the second reinforcing member 11 can may be configured to improve strength of the audio device. The first reinforcing member 10 is located between the support 6 and the flexible circuit board 5, and is located around the microphone 4. The second reinforcing member 11 is located between the flexible circuit board 5 and the seal member 12. The seal member 12 is configured to seal the flexible circuit board 5 and the structural member of the terminal device 1. The back adhesive 13 may be configured to bond the first reinforcing member 10 to the support 6 and bond the first reinforcing member 10 to the flexible circuit board 5. In addition, the back adhesive 13 may be further configured to bond the second reinforcing member 11 to the flexible circuit board 5 and bond the second reinforcing member 11 to the seal member.

To make the solutions provided in this application clear, the solutions provided in this application are described below through embodiments with reference to the drawings.

An embodiment of this application provides an audio device. Referring to FIG. 5, the audio device includes a microphone 4, a flexible circuit board 5, and a support 6.

The microphone 4 is located between the support 6 and flexible circuit board 5. In a feasible design, the support 6 may be a main board support of the terminal device 1.

In addition, a contact region between the flexible circuit board 5 and the microphone 4 includes a first hole for an airflow of audio to circulate. In addition, after the audio device is mounted to the terminal device 1, the airflow of the audio may flow from the structural member of the terminal device 1 to the microphone 4 through the first hole, so that the microphone 4 receives the airflow of the audio.

In the audio device, the microphone 4 is located between the support 6 and the flexible circuit board 5, and the support 6 can provide a supporting function. Therefore, through the audio device 1, a risk that the microphone 4 falls off the support 6 can be reduced even if no supporting member is arranged, thereby resolving a problem in the prior art that a space needs to be reserved in the terminal device 1 for a supporting member due to a need to arrange the supporting member. In addition, in the solutions of this application, because no space needs to be reserved in the terminal device 1 for the supporting member, the terminal device 1 can be lighter and thinner.

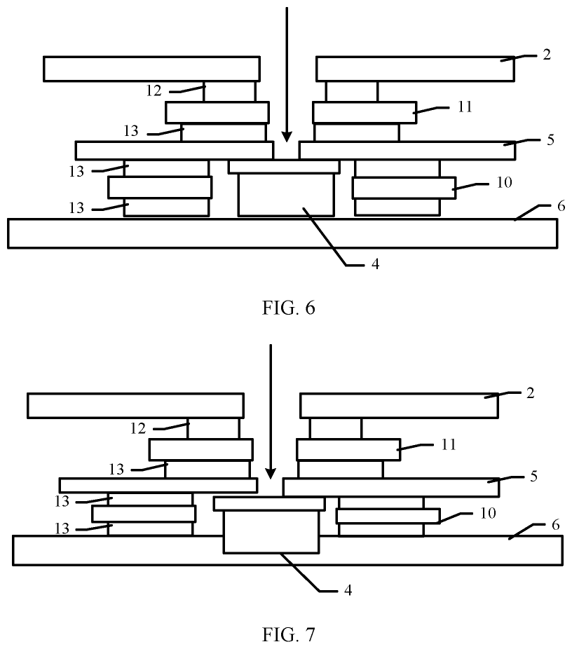

Further, referring to FIG. 6, the audio device provided in this embodiment of this application further includes a first reinforcing member 10. The first reinforcing member 10 is located between the support 6 and the flexible circuit board 5, and is located around the microphone 4. For example, the first reinforcing member 10 may surround the microphone 4.

The first reinforcing member 10 may be connected to the support 6 in various manners. For example, in a feasible design, a first side of the first reinforcing member 10 is welded to the support 6. Alternatively, in another feasible design, the first side of the first reinforcing member 10 is bonded to the support 6 through a back adhesive 13. Certainly, the first reinforcing member 10 may be connected to the support 6 in another manner. This is not limited in this embodiment of this application.

In addition, the first reinforcing member 10 may be connected to the flexible circuit board 5 in various manners. For example, in a feasible design, a second side of the first reinforcing member 10 is welded to the flexible circuit board 5. Alternatively, in another feasible design, the second side of the first reinforcing member 10 is bonded to the flexible circuit board 5 through the back adhesive 13. The first side of the first reinforcing member 10 is opposite to the second side of the first reinforcing member 10. Certainly, the first reinforcing member 10 may be connected to the flexible circuit board 5 in another manner. This is not limited in this embodiment of this application.

The first reinforcing member 10 may be configured to improve strength of the audio device. The first reinforcing member 10 may include a metal member, such as a steel sheet. Alternatively, the first reinforcing member 10 may include a composite fiber member. Certainly, the first reinforcing member 10 may further include another device that can improve the strength of the audio device. This is not limited in this embodiment of this application.

The audio device provided in this embodiment of this application further includes a seal member 12.

When the audio device is arranged in the terminal device 1, a space between the flexible circuit board 5 and the structural member of the terminal device 1 is sealed by the seal member 12. The structural member may be a cover or a housing of the terminal device 1. For example, if the terminal device 1 is a mobile phone, the structural member may be a battery cover or a mobile phone housing of the mobile phone.

The seal member 12 includes a second hole for the airflow of the audio to circulate. Generally, a centerline of the second hole may be the same as a centerline of the first hole. The second hole and the first hole form an airflow channel, so that the airflow of the audio flows into the microphone 4.

The seal member 12 includes foam and/or a back adhesive. Certainly, the seal member 12 may be made of another material with a sealing function. This is not limited in this embodiment of this application.

Further, the audio device provided in this embodiment of this application further includes a second reinforcing member 11.

The second reinforcing member 11 is located between the flexible circuit board 5 and the seal member 12. The second reinforcing member 11 includes a third hole for the airflow of the audio to circulate.

The first hole, the second hole, and the third hole form an airflow channel. When the audio device is arranged in the terminal device 1, the airflow of the audio may flow from the structural member of the terminal device 1 to the microphone 4 through the airflow channel. In a feasible design, centerlines of the first hole, the second hole, and the third hole are located on a same straight line.

The second reinforcing member 11 may be connected to the flexible circuit board 5 in various manners. For example, in a feasible design, a first side of the second reinforcing member 11 is welded to the flexible circuit board 5. Alternatively, in another feasible design, the first side of the second reinforcing member 11 is bonded to the flexible circuit board 5 through the back adhesive 13. Certainly, the second reinforcing member 11 may be connected to the flexible circuit board 5 in another manner. This is not limited in this embodiment of this application.

In addition, the second reinforcing member 11 may be connected to the seal member 12 in various manners. For example, in a feasible design, a second side of the second reinforcing member 11 is welded to the seal member 12. Alternatively, in another feasible design, the second side of the second reinforcing member 11 is bonded to the seal member 12 through the back adhesive 13. The first side of the second reinforcing member 11 is opposite to the second side of the second reinforcing member 11. Certainly, the second reinforcing member 11 may be connected to the seal member 12 in another manner. This is not limited in this embodiment of this application.

The second reinforcing member 11 may be configured to improve the strength of the audio device. In addition, the second reinforcing member 11 may include a metal member, such as a steel sheet. Alternatively, the second reinforcing member 11 may include a composite fiber member. Certainly, the second reinforcing member 11 may further include another device that can improve the strength of the audio device. This is not limited in this embodiment of this application.

In a possible design of embodiments of this application, a first surface of the flexible circuit board 5 covers a surface of the second side of the first reinforcing member 10. The first surface of the flexible circuit board 5 is a surface of the flexible circuit board 5 connected to the first reinforcing member 10. The surface of the second side of the first reinforcing member 10 is a surface of the first reinforcing member 10 connected to the flexible circuit board 5.

In this solution, that the first surface of the flexible circuit board 5 covers the surface of the second side of the first reinforcing member 10 means that an area of the surface of the flexible circuit board 5 connected to the first reinforcing member 10 is greater than an area of the surface of the second side of the first reinforcing member 10. The flexible circuit board 5 has a characteristic of being bendable. During use of the terminal device 1, the flexible circuit board 5 may be bent based on a user demand. Because the first surface of the flexible circuit board 5 covers the surface of the second side of the first reinforcing member 10, impact of the first reinforcing member 10 on the bending of the flexible circuit board 5 can be avoided.

In addition, in another possible design of embodiments of this application, a second surface of the flexible circuit board 5 covers a surface of the first side of the second reinforcing member 11. The second surface of the flexible circuit board 5 is a surface of the flexible circuit board 5 connected to the first reinforcing member 10. The surface of the first side of the second reinforcing member 11 is a surface of the second reinforcing member 11 connected to the flexible circuit board 5.

In this solution, that the second surface of the flexible circuit board 5 covers the surface of the first side of the second reinforcing member 11 means that an area of the surface of the flexible circuit board 5 connected to the second reinforcing member 11 is greater than an area of the surface of the first side of the second reinforcing member 11. In this way, impact of the second reinforcing member 11 on the bending of the flexible circuit board 5 can be avoided.

In the audio device provided in this embodiment of this application, the microphone 4 is located between the flexible circuit board 5 and the support 6. In a feasible design, the support 6 has a flat surface. In other words, the support 6 includes no groove.

Alternatively, in another possible design, referring to the schematic structure shown in FIG. 7, the support 6 includes a groove, and the microphone 4 is located in the groove.

The microphone 4 is located in the groove of the support 6. Therefore, a height of the audio device can be reduced, so that a space occupied by the audio device is further reduced, which helps improve lightening and thinning of the terminal device.

A range of a depth of the groove included in the support 6 varies with a type and a volume of the terminal device 1. If the terminal device 1 is a mobile phone, in a possible design, the depth of the groove may be in a range of 0.5 mm to 1.5 mm. In an example, the depth of the groove is 0.5 mm. Alternatively, in another example, the depth of the groove is 1.5 mm.

In addition, if the support 6 includes the groove, a bottom of the microphone 4 may contact the groove, or a gap may exist between the bottom of the microphone 4 and the groove. In this case, if the terminal device 1 is a mobile phone, a distance between the bottom of the microphone 4 and the groove may be in a range of 0.05 mm to 0.25 mm. In an example, the distance between the bottom of the microphone 4 and the groove may be 0.05 mm. Alternatively, in another example, the distance between the bottom of the microphone 4 and the groove may be 0.25 mm.

Another embodiment of this application provides a terminal device. The terminal device includes the audio devices disclosed in the foregoing embodiments.

In the terminal device, the supporting member for supporting the microphone does not need to be arranged for the audio device. Therefore, no space needs to be reserved for the supporting member. The terminal device provided in this embodiment of this application can be thinner and lighter than an existing terminal device.

Further, in the solutions provided in embodiments of this application, the screen of the terminal device may be a flexible screen. The flexible screen may include a single-curve screen, a dual-curve screen, a triple-curve screen, a quad-curve screen, a flat screen, a folding screen, a rollable screen, and the like. This is not limited in embodiments of this application.

For same or similar parts of the embodiments in this specification, reference may be made to each other, and each embodiment focuses on a difference from other embodiments. In particular, because device and system embodiments are similar to method embodiments, they are described simply. For related parts, reference may be made to descriptions of the method embodiments.

The implementations of the present invention described above do not limit the protection scope of the present invention.

1.-14. (canceled)

15. A terminal device, comprising:
a flexible circuit board;
a support;
a seal member;
a structural member, wherein a space between the flexible circuit board and the structural member is sealed by the seal member;
a microphone located between the support and the flexible circuit board, wherein a contact region between the flexible circuit board and the microphone comprises a first hole for an airflow of audio energy to circulate;
a first reinforcing member located between the support and the flexible circuit board; and
a second reinforcing member located between the flexible circuit board and the seal member.

16. The terminal device of claim 15, wherein the support comprises a groove, and the microphone is located in the groove.

17. The terminal device of claim 16, wherein a depth of the groove is in a range of 0.5 millimeters (mm) to 1.5 mm, and wherein a distance between a bottom of the microphone and the groove is in a range of 0.05 mm to 0.25 mm.

18. The terminal device of claim 15, wherein the first reinforcing member is located around the microphone.

19. The terminal device of claim 18, wherein a first side of the first reinforcing member is welded to the support, or wherein the first side of the first reinforcing member is bonded to the support through a back adhesive.

20. The terminal device of claim 19, wherein a second side of the first reinforcing member is welded to the flexible circuit board, or wherein the second side of the first reinforcing member is bonded to the flexible circuit board through the back adhesive.

21. The terminal device of claim 20, wherein the first side of the first reinforcing member is opposite to the second side of the first reinforcing member.

22. The terminal device of claim 21, wherein a first surface of the flexible circuit board covers a surface of the second side of the first reinforcing member, and wherein the first surface of the flexible circuit board is a surface of the flexible circuit board connected to the first reinforcing member.

23. The terminal device according to of claim 22, wherein a second surface of the flexible circuit board covers a surface of the first side of the second reinforcing member; and the second surface of the flexible circuit board is a surface of the flexible circuit board connected to the first reinforcing member.

24. The terminal device of claim 15, wherein the first reinforcing member comprises a metal member or a composite fiber member.

25. The terminal device of claim 15, wherein the seal member comprises foam and/or a back adhesive.

26. The terminal device of claim 25, wherein the seal member comprises a second hole for the airflow of the audio energy to circulate.

27. The terminal device of claim 26, wherein the second reinforcing member comprises a third hole for the airflow of the audio energy to circulate.

28. The terminal device of claim 27, wherein either a) a first side of the second reinforcing member is welded to the flexible circuit board, or b) the first side of the second reinforcing member is bonded to the flexible circuit board through the back adhesive, wherein either c) a second side of the second reinforcing member is welded to the seal member, or d) the second side of the second reinforcing member is bonded to the seal member through the back adhesive, and wherein the first side of the second reinforcing member is opposite to the second side of the second reinforcing member.

29. The terminal device of claim 15, wherein the structural member comprises a cover or a housing.

30. The terminal device of claim 15, wherein the seal member comprises a second hole for the airflow of the audio energy to circulate.

31. The terminal device of claim 30, wherein the second reinforcing member comprises a third hole for the airflow of the audio energy to circulate.

32. The terminal device of claim 31, wherein centerlines of the first hole, the second hole, and the third hole are located on a same straight line.

33. The terminal device of claim 31, wherein the first hole, the second hole, and the third hole form an airflow channel to provide the airflow of the audio energy from the structural member to the microphone.

34. An audio device, comprising:
a flexible circuit board;
a support;
a seal member;
a microphone located between the support and the flexible circuit board, wherein a contact region between the flexible circuit board and the microphone comprises a first hole for an airflow of audio energy to circulate;
a first reinforcing member located between the support and the flexible circuit board; and
a second reinforcing member located between the flexible circuit board and the seal member.
